(19) United States
(12) Patent Application Publication
(10) Pub. No.: US 2011/0210110 A1
(43) Pub. Date: Sep. 1, 2011

(54) Method and Apparatus for Automated Welding

(76) Inventors: Stephen Dearman, Geismar, LA (US); Jorge Tarajano, Baton Rouge, LA (US); Brian Riddle, Port Allen, LA (US); Jacob Coots, Baton Rouge, LA (US)

(21) Appl. No.: 13/034,310

(22) Filed: Feb. 24, 2011

Related U.S. Application Data
(60) Provisional application No. 61/308,615, filed on Feb. 26, 2010.
(60) Provisional application No. 61/376,128, filed on Aug. 23, 2010.

(51) Int. Cl. B23K 9/00

(52) U.S. Cl. 219/137 R; 219/136

(57) ABSTRACT

A method of welding plate joints during construction or repair of a structure. The method includes the steps of: (a) positioning a series of plates forming a structure component next to one another to form a series of joints for welding; (b) positioning a welding system on or adjacent to the series of plates, the welding system including a platform with an articulating welding arm positioned thereon, wherein the articulating arm comprises a welding head and a joint sensor; (c) directing the articulating arm with a controller to detect a first joint with the joint sensor; (d) beginning to weld the first joint; (e) adjusting the position of the welding head to track the weld joint based on data from the joint sensor; and (f) repositioning the articulating arm and positioning the welding head adjacent a second weld joint to begin welding the second joint.

This application claims the benefit under 35 USC §119(e) of U.S. provisional applications Ser. Nos. 61/308,615 filed Feb. 26, 2010 and 61/376,128 file Aug. 23, 2010, both of which are incorporated by reference herein in their entirety.

### I. BACKGROUND OF INVENTION

The present invention generally relates to apparatuses and methods for welding and in more specific embodiments, to automated welding systems used in the construction and repair of large storage tanks.

Large diameter cylindrical storage tanks are typically constructed and repaired in chemical plants, pulp mills, municipal water or oil related plants for the storage of products. Conventionally these tanks are fabricated on site from a large number of relatively small pre-formed heavy gauge steel plates. Typically, the steel plates are lifted and placed by a crane or other lifting device and are then hand fitted, tack-welded and finally welded in place. Scaffolding often must be erected around the tank to allow the workers to work at the height of the tank under construction. Likewise, repair of existing tanks often requires significant welding resources to install replacement plates, reinforcing plates, etc. Improved devices and methods for more efficient welding of the joints between these plates would offer significant economic benefits.

### II. SUMMARY OF SELECTED EMBODIMENTS OF THE INVENTION

One embodiment is a method of welding plate joints during construction or repair of a structure, the method comprising the steps of: (a) positioning a series of plates forming a structure component next to one another to form a series of joints for welding; (b) positioning a welding system on or adjacent to the series of plates, the welding system including a platform with an articulating welding arm positioned thereon, wherein the articulating arm comprises a welding head and a joint sensor; (c) directing the articulating arm with a controller to detect a first joint with the joint sensor; (d) beginning to weld the first joint; (e) adjusting the position of the welding head to track the weld joint based on data from the joint sensor; and (f) repositioning the articulating arm and positioning the welding head adjacent a second weld joint to begin welding the second joint.

Another embodiment is an automated welding system comprising: (a) a welding platform; (b) a self-positioning arm mounted on the platform, the self-positioning arm including a rotating base and at least two arm segments connected at a pivot point; (c) a welding machine including a welding head attached to the self-positioning arm; (d) a weld joint sensor; and (e) a controller communicating with the self-positioning arm, the joint sensor, and the welding machine, wherein the controller is programmed to adjust the position of the welding head to track the weld joint.

### III. BRIEF DESCRIPTION OF THE DRAWINGS

FIG. 1 illustrates one embodiment of the welding system positioned on a series of plates which will form the floor of a storage tank.

FIG. 2 illustrates a more detailed view of the welding cart component of the system seen in FIG. 1.

FIG. 3 illustrates a more detailed view of the controller cart component of the system seen in FIG. 1.

FIGS. 4A through 4D illustrate alternate cart platform embodiments.

FIG. 5 is a hardware controller schematic diagram of one embodiment of the welding system.

FIG. 6 is a flow chart illustrating high level programming architecture in one embodiment of the welding system.

FIG. 7 illustrates another embodiment of the welding system of the present invention.

FIG. 8 illustrates an alternate secondary cart or platform for the system of FIG. 7.

FIG. 9 is an enlarged view of a bracket positioned on the articulating arm of the FIG. 7 embodiment.

FIG. 10 is a hardware diagram of the welding system of FIGS. 7 and 8.

FIG. 11 is a flow chart illustrating high level programming architecture of the FIG. 7 embodiment.

### IV. DETAILED DESCRIPTION OF THE INVENTION

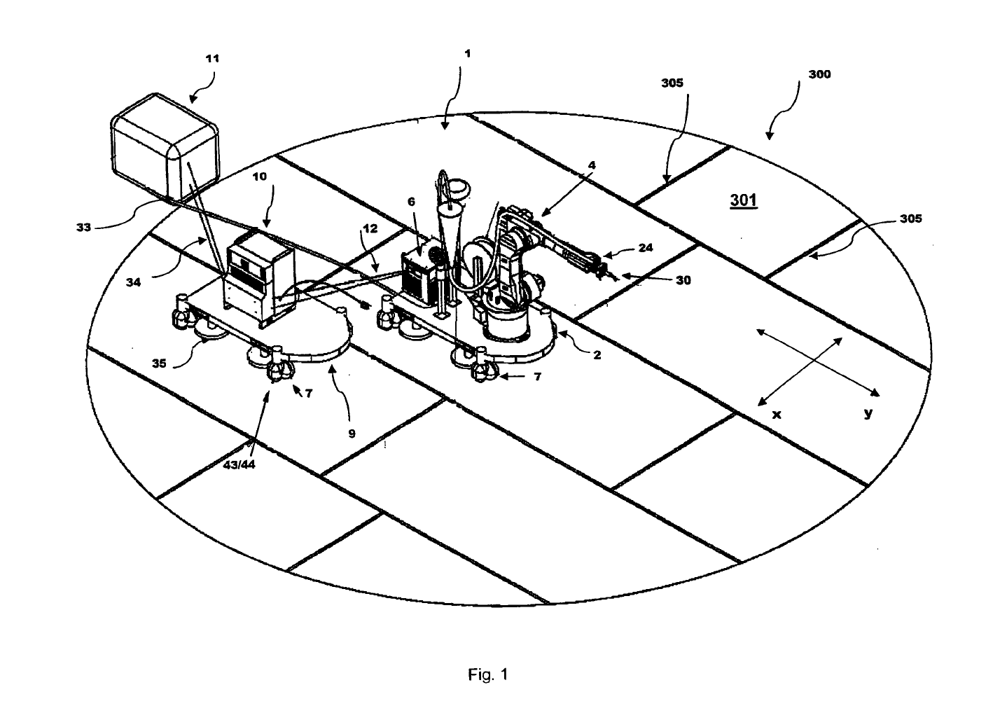

One embodiment of the welding system of the present invention is illustrated in FIG. 1. Welding system 1 generally provides a self-propelled cart 2 having a self-positioning arm 4 mounted on the cart 2. The welding system will include a welding machine 6, which in the embodiment of FIG. 1 is positioned directly on cart 2. A welding torch or weld head 30 is positioned on the self-positioning arm 4. Finally, this basic welding system will further include a weld joint sensor 24 and a system controller 10 which directs the operations of the system components. FIG. 1 illustrates the welding system 1 positioned on a tank component 300 (e.g., a tank bottom, side, or top) constructed from a series of individual plates 301 which form joints 305 between the plates 301.

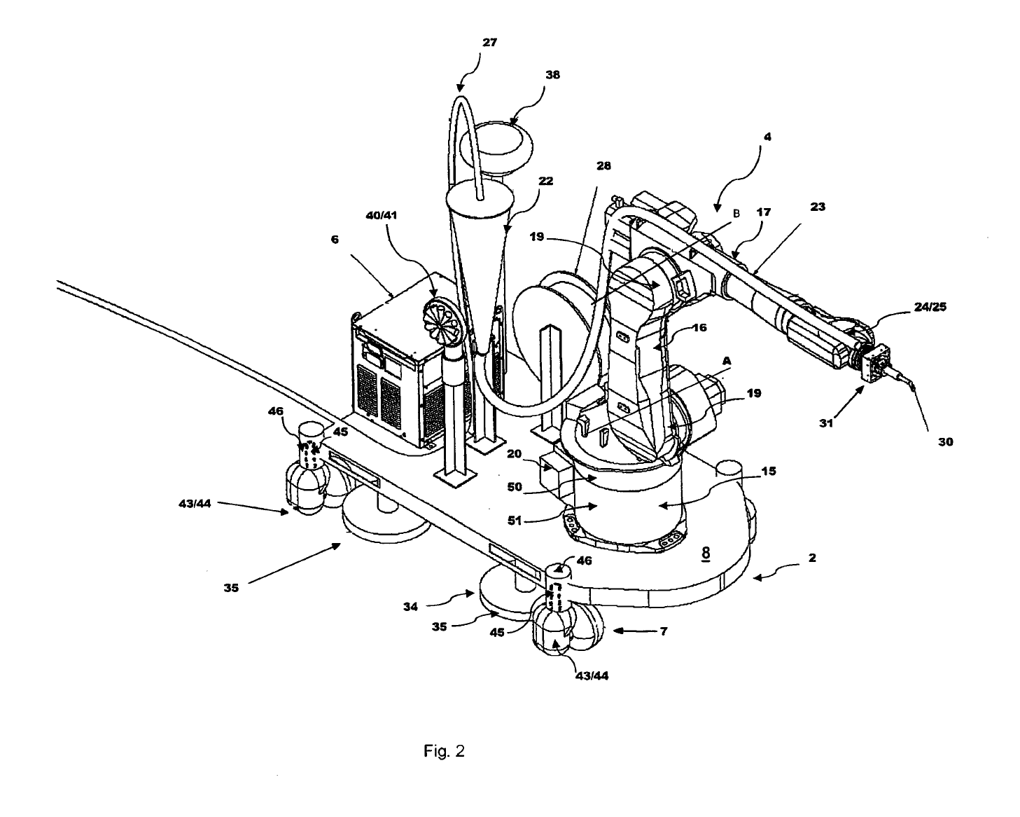

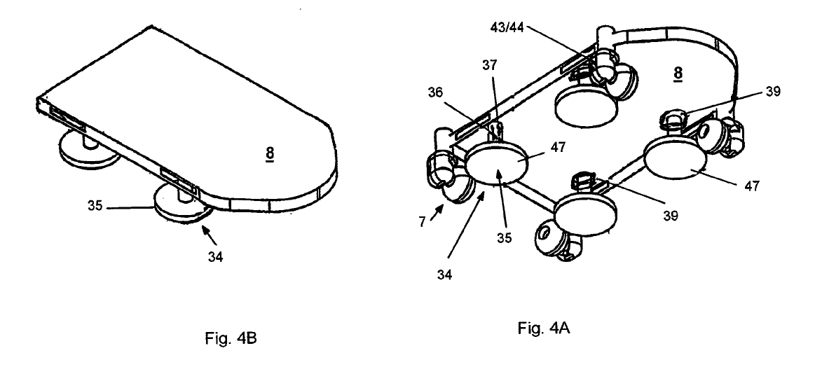

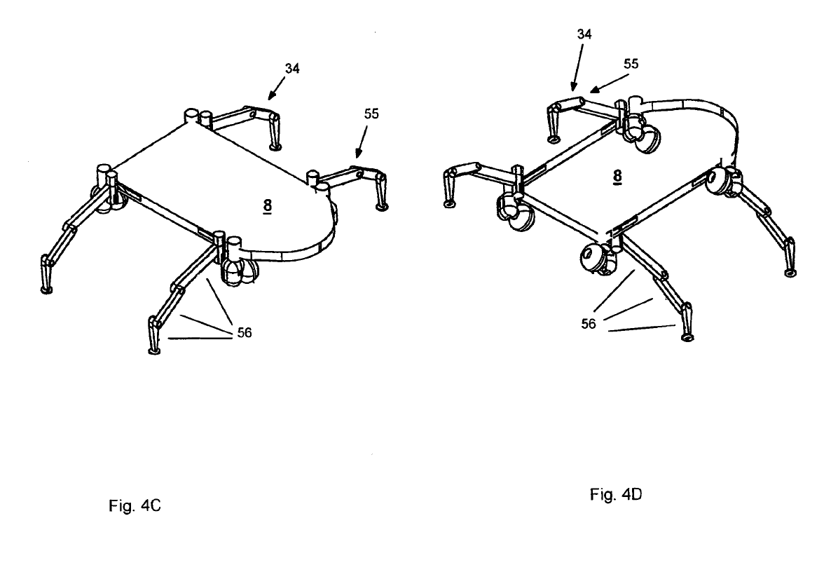

Viewing FIG. 2, the self-propelled cart 2 comprises substantially flat base platform 8 to which a series of wheels 7 will be attached. The wheels seen in FIG. 2 are caster-type wheels, but could be any conventional wheels constructed of materials such as rubber, steel, or polyurethane. In this embodiment, wheel mounts 46 will be attached to base platform 8 and wheel pins 45 extend from wheels 7 and engage wheel mounts 46 in a fixed or non-pivoting manner. Positioned between wheels 7 and wheel pins 45 are drive servo motor 43 and steering servo motor 44. In one embodiment, these servo motors may be Baldor Electric Company (of Fort Smith, Ark.) BSM C-series servo motors combined with the BSM series gear-head (e.g., with the gear-head positioned between the servo motor and the wheel axle). Drive servo motor 43 will provide torque to wheels 7 and thereby provide the self-propulsion for cart 2. Steering servo motor 44 will apply torque to wheel pins 45, thus rotating wheels 7 relative to wheel pins 45, and thereby providing a steering mechanism for cart 2. FIGS. 2 and 4A show how certain carts 2 further include a series of stabilizing legs 34. In FIG. 4A, the components on base platform 8 have been removed for simplicity of illustration. In the illustrated embodiment, stabilizing legs 34 are power screw driven legs 35. The legs 35 will generally comprise an internally threaded sleeve 37 attached to a disc-shaped footing 47. Internally threaded sleeves 37 engage a threaded post 36 which is connected to base platform 8. Servo motors 39 will rotate sleeves 37 relative to post 36 in order to raise and lower legs 35. It can be visualized how legs 35 will be raised when base platform 8 is being moved from one tank area to the next and then be lowered into position to firmly engage the floor plates prior to welding operations.

FIGS. 4C and 4D illustrate an alternative embodiment of stabilizing legs 34, i.e., out rigger legs 55. In can be seen how out rigger legs 55 are formed by a series of leg segments 56 which are pinned together and attached to base platform 8. Although not specifically shown in the figures, the leg segments 56 may be interconnected by linear actuators such as power screws or hydraulic (or pneumatic) piston and cylinder assemblies. Retracting or extending the linear actuators would move out rigger legs 55 between the retracted and the deployed position.

A still further embodiment not illustrated could include disc-shaped electro-magnets (appearing much like power screw driven legs 35) which slide on posts connected to the bottom of base platform 8. The spacing between the sleeves and the posts would be such that the electro-magnets could be raised a slight distance above the bottom of wheels (i.e., clearing the tank floor plates on which cart 2 travels), but may also slide down the posts far enough to firmly engage the floor plates. Retracting springs would bias the electro-magnets upward when the magnets were not energized. However, when the electro-magnets were energized, the magnetic force would overcome the retracting springs and the magnets would firmly engage the floor plates. Although not shown in the drawings, various designs of mechanical linkage could alternatively be used (i.e., rather than power screws or linear actuators) to lower and raise any of the stabilizing legs 34 described above.

An alternate embodiment of platform 8 seen in FIG. 4B will have no wheels and will not be self-propelled and may be considered “stationary.” This embodiment of the platform is stationary in the sense that the platform may be moved, but must be moved by an external mechanism. For example, the platform may be manually carried from position to position between joint welding operations and electro-magnets 35 activated when a welding operation is in progress. Of course, alternate embodiments could employ non-magnetic stabilizing legs 34 or no stabilizing leg whatsoever.

Returning to FIG. 2, another major component of welding system 1 is the self-positioning arm 4 (which may also be referred to as “articulating arm” 4 herein). This embodiment of self-positioning arm 4 will generally comprise a rotating base 15, with first arm segment 16 and second arm segment 17. Rotating base 15 further includes a lower section 51 which is connected to cart base platform 8 and an upper section 50 which is able to rotate relative to lower section 51. Although hidden from view, a servo-motor in rotating base 15 will control the rotative position of upper section 50 relative to lower section 51. First arm segment 16 is connected to rotating base 15 by the pivot joint 19 which includes its own servo motor to allow first arm segment 16 to controllably rotate around the axis A seen in FIG. 2. In a similar manner, second arm segment 17 is connected to first arm segment 16 by another pivot joint 19 which includes its own servo motor to allow second arm segment 17 to controllably rotate around the axis B seen in FIG. 2. The system controller 10 will coordinate the operation of the servo motors which guide the tool on the end of the second arm segment 17 to the desired location within reach of self-positioning arm 4. One example of a commercially available self-positioning arm is the KR60-4 KS manufactured by KUKA Roboter GmbH of Augsburg, Germany. In FIG. 2, self-positioning arm 4 is shown with a robot tool changer 31 positioned on the end of second arm segment 17. The robot tool changer 31 will have a conventional quick connect/disconnect head allowing the tool changer to selectively switch between tools (e.g., weld head tip, buffing tool, grinding tool, etc.). Other embodiments of self-positioning arm 4 may lack the rotating base, have a different number of arms, or not include a tool changer.

This embodiment further includes a joint sensor 24 which will detect the plate joints 305 (see FIG. 1) when the end of second arm segment 17 is positioned close to the plate joints 305. In one example, the joint sensor is a conventional “thru-arc” sensing mechanism which measures changes in the welding arc voltage/current in order to identify the proximity of the welding torch tip to the surface being welded. Conventional software for conducting thru-arc sensing is available from ABB Group of Zurich, Switzerland. In a second example, the joint sensor may be a camera system which senses contrasting images to identify the location of the weld joint. A conventional camera system performing this function is a True View 5.12 Vision Guided Robotics system manufactured by ABB Group. In a third example, the joint sensor could be a mechanical wand extending in proximity to the weld head which senses physical contact with the weld joint.

FIG. 2 further shows this embodiment of welding system 1 as having a pressurized flux feed system. The flux hopper 22 will serve as a reservoir for weld flux powder and pressurized air from hose 27 will serve as the driving force to propel the flux power through flux hose 23 and onto the weld surface leading the torch as is well known in conventional welding practice. Other embodiments could employ a gravity fed flux system or not employ any type of flux delivery system. Still further embodiments could employ a flux recovering system such as a vacuum source fixed to second arm segment 17 in a trailing position behind the torch.

FIG. 2 also illustrates a motion detector 38 acting as a safety device. If motion detector 38 senses movement (e.g., a person inadvertently encroaching on the welding area) within a proximity considered unsafe, the motion detector will initiate a safety shut-down of the welding system. In one embodiment, motion detector 38 is a sonic-based sensor. Alternative sensors could include, infra-red bases sensors, mechanical sensors, or electro-mechanical sensors.

Another feature seen in FIG. 2 is a weld wire spool 28 which provides a continuous supply of the welding wire consumed by the arc-type welding system illustrated in the figures. The wire may be solid wire, metal core wire, or any other conventional or future developed wire. One non-limiting example of a metal core wire is Tri-Mark EM13K-S which could be used with HN-590 flux powder, both manufactured by Hobart Brothers, Inc. of Troy, Ohio. For the sub-arc welding process shown in the figures, an arc welding machine 6 will need to be a component of the system. Although FIG. 2 shows the welding machine 6 positioned on cart 2, other embodiments could position the welding machine on the secondary cart 9 (explained below), or could even position welding machine 6 outside the perimeter of the tank plates seen in FIG. 1 with cables extending to the welding torch 30. Although the welding machine 6 seen in the figures is an arc welding machine, other embodiments could employ welding hardware associated with an induction welding system, a plasma welding system, or a laser welding system.

Returning to FIG. 1, it can be seen how this embodiment of welding system 1 includes secondary cart 9 which has the welding system controller 10 positioned thereon. In the illustrated embodiment, secondary cart 9 is self-propelled with the wheels 7, servo drive and steering motors 43/44, and electro-magnet stabilizing legs 35 all as shown described above. However, alternative secondary carts 9 could operate without stabilizing legs or without servo drive and steering motors. For example, secondary cart 9 could simply have conventional caster wheels and a tether to self-propelled cart 2 such that secondary cart 9 is pulled along or towed behind self-propelled cart 2.

The embodiment of FIG. 1 also shows the power generator 11 positioned off the tank floor plates and having lower power supply cables 34 powering the system controller 10 and higher power supply cable 33 for powering welding machine 6. FIG. 1 also illustrates a communication link 12 between controller 10 and the components on cart 2. In one embodiment, communications link 12 is hard wiring. However, in other embodiments, communication link 12 could be a wireless link such as a wi-fi, infra-red, or other conventional or future developed wireless communication system.

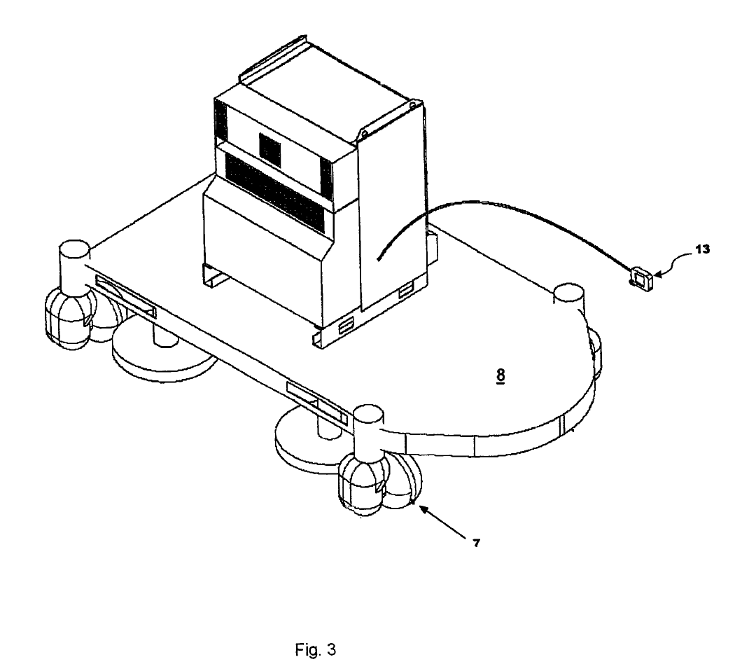

In the embodiment of FIG. 3, the system controller 10 will include a user interface pendent 13. One example pendent 13 includes a small view screen and a key-pad such found in the commercially available R-30: A Teach Pendent manufactured by FANUC Robotics America, Inc. of Rochester Hills, Mich. Pendent 13 may have directional arrow keys, and/or a joy stick, and/or numerical keys allowing a user to enter numerical information and directional instructions through pendent 13. It will be understood that pendent 13 may be used to enter instructions for controlling the position of cart 2 (when self-propelled) and self-positioning arm 4.

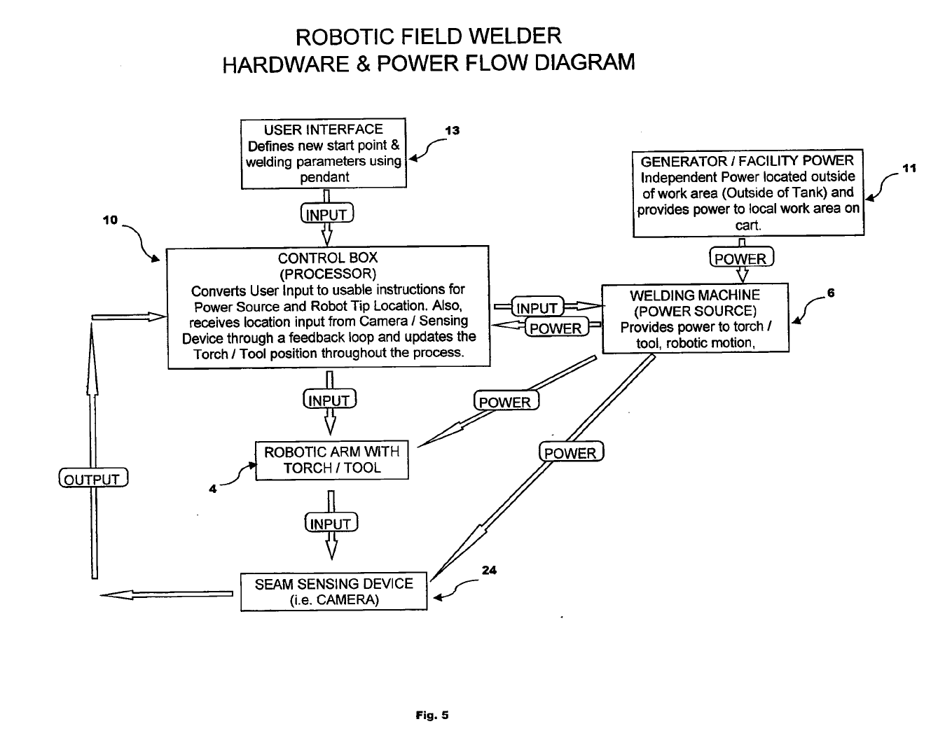

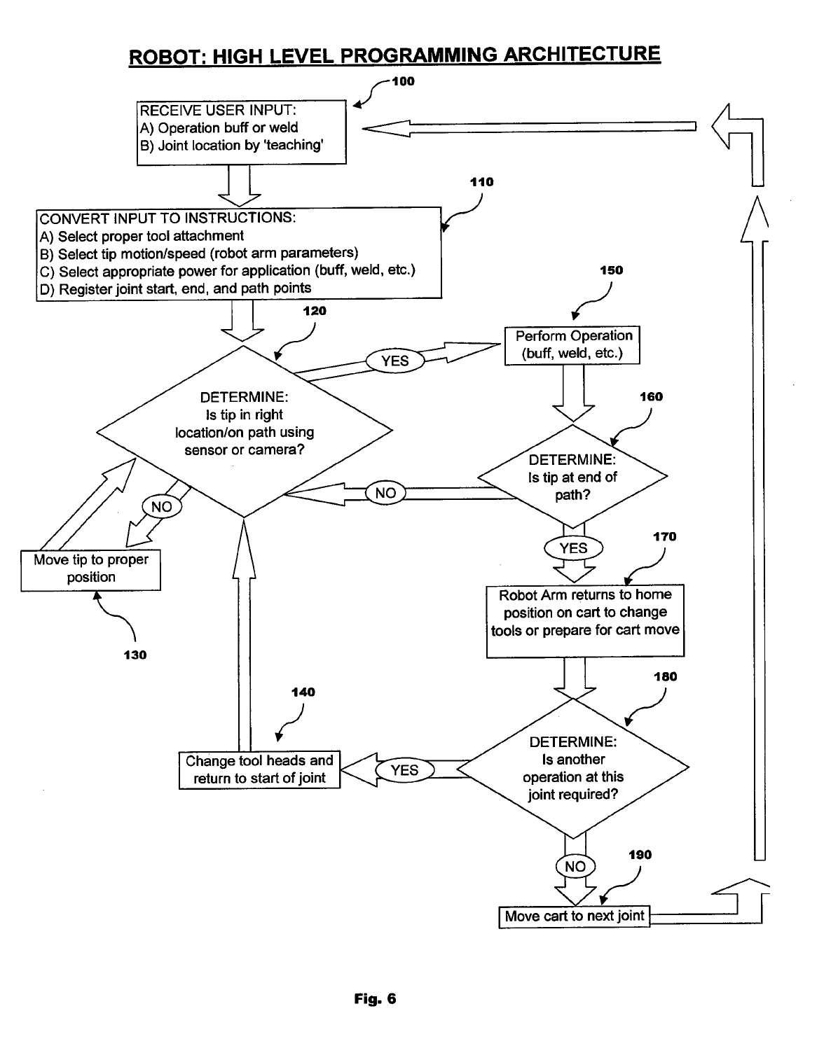

FIG. 5 is a control schematic illustrating the flow of instructions and power between certain components in welding system 1. The user interface pendent 13 will be employed by the user to define a welding start point and the welding parameters associated therewith. Pendent 13 will provide input to system controller 10, which includes a computer processor and software for carrying out the control steps described herein. For example, controller 10 will convert user inputs to instructions readable by welding machine 6 and the self-positioning arm 4. Controller 10 will also receive weld head location information from joint sensor 24 and through feedback loops will update the weld head position throughout the process. Likewise, controller 10 will also control the variable power from welding machine 6 needed by the weld head for welding operations while generator 11 will provide a general power supply to welding machine 6.

FIG. 6 illustrates the high level programming architecture for one embodiment of the welding system. In step 100, the system receives a user input (e.g., from pendent 13) regarding the operation to be undertaken (e.g., welding, buffing, repositioning of cart 2, etc.). The system may also ascertain the relevant weld joint location through a “teaching” process. This process may be performed by the user employing the pendent 13 to guide weld head into contact with the weld joint at a first point. The system controller 10 will acknowledge the weld head is next to the joint (e.g., by touch sensing if using a mechanical joint sensor) and the user will use pendent 13 to instruct the controller 10 to save this point as a start/stop/linear point on the weld path. This process may be used multiple times to define the weld path. Once this operation is complete, the controller 10 virtually knows the weld path, at least well enough, to begin welding. This process will typically be performed after every cart move.

In step 110, the user's tool instructions (e.g., welding, buffing, etc.) activates programmed functions such as selecting the proper tool attachment, the proper motion/speed, and the appropriate power level. Controller 10 will register joint start, end, and path points in preparation for commencing the work activity. In step 120, controller 10, using feedback from joint sensor 24, determines whether the tool tip is in the correct position relative to the weld joint. If not, the controller 10 performs a loop between steps 120 and 130 until the correct position is detected. Thereafter, step 150 initiates the selected operation. In step 160, controller 10 determines whether the tool tip has reached the end of the earlier determined weld path. If not, a loop between steps 120, 150, and 160 are continued until the condition is fulfilled. In step 170, the self-positioning arm 4 returns to its home position in preparation for a tool change or movement of cart 2. In step 180, controller 10 determines whether another operation at the same weld joint is required. If yes, self-positioning arm 4 is directed to change tool heads and the controller logic returns to step 120. If no, then the user in step 190 inputs through pendent 13 information which moves the cart 2 to the next weld joint and the controller logic returns to step 100.

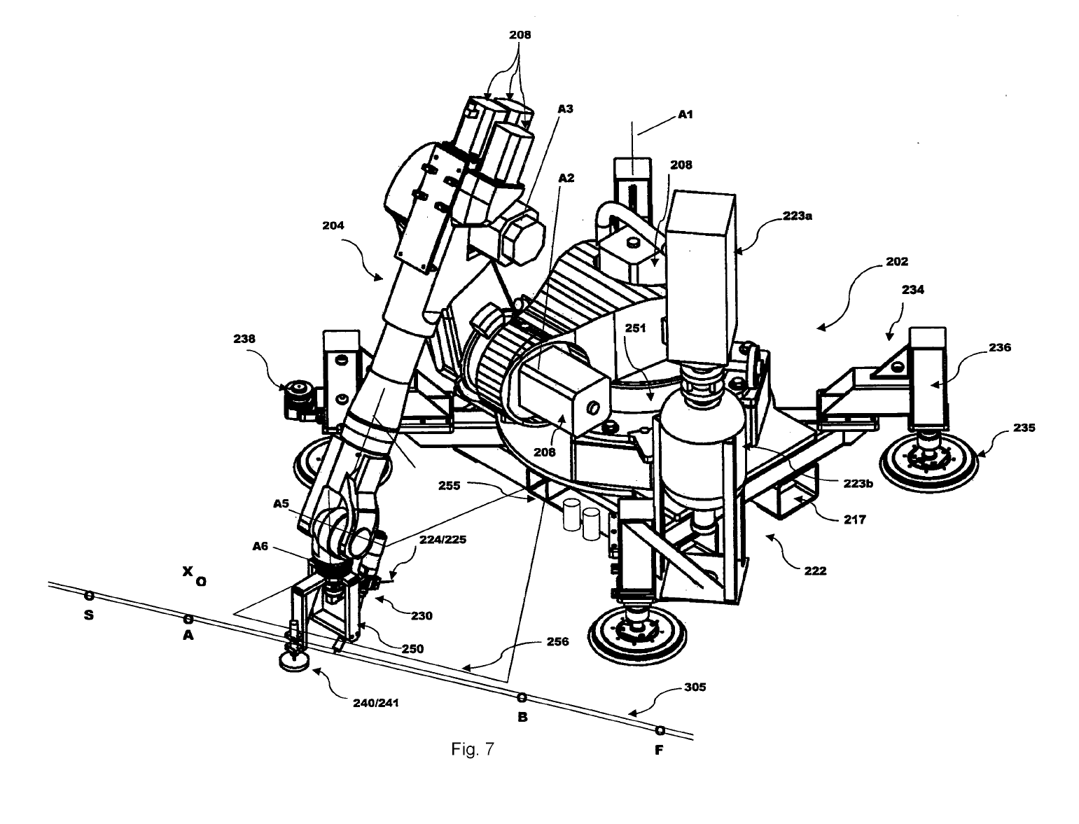

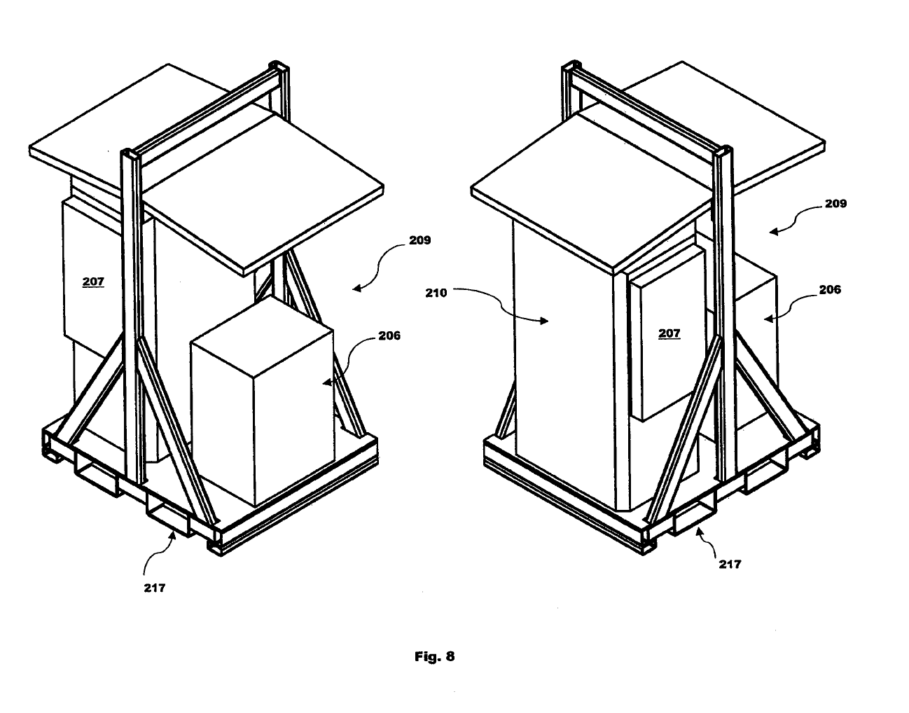

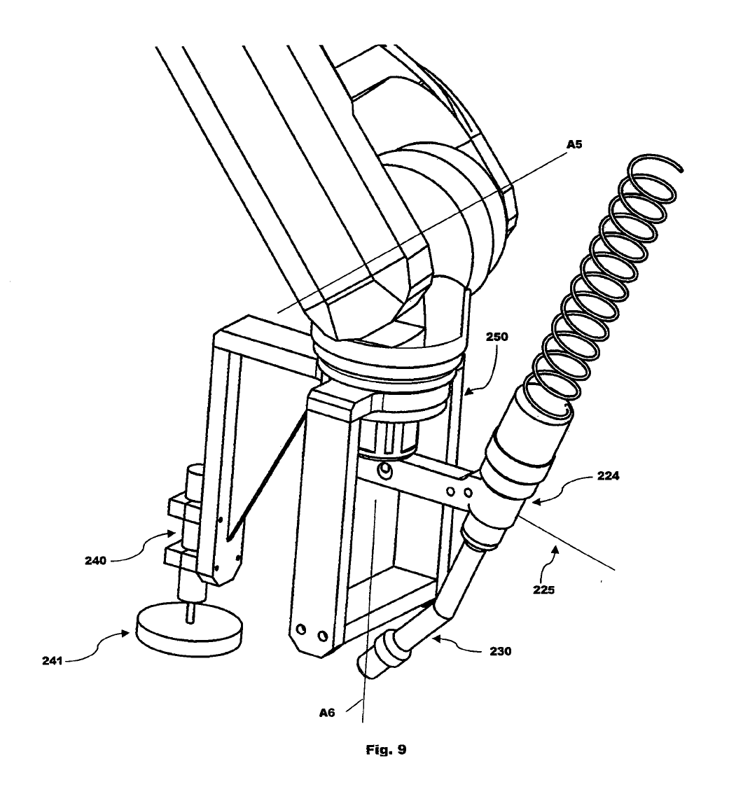

Another embodiment of the welding system is seen in FIGS. 7 to 11. FIG. 7 illustrates a welding cart or platform 202 while FIG. 8 illustrates a secondary (or accessory) cart or platform 209. Although not explicitly illustrated, it will be understood that these two platforms will typically be used together as suggested in FIG. 1. The welding cart 202 seen in FIG. 7 includes the self-positioning arm 204 mounted on rotating base 251, which in one embodiment are parts of the KUKA KR60-4 KS robot referenced above. Self-positioning arm 204 may alternatively be referred to herein as an “articulating arm” or a “robot arm.” FIG. 7 suggests how the KUKA robot provides six degrees of rotative freedom on the self-positioning arm 204. The axes of rotation are as described above and include axes A1, A2, A3, A4, A5, and A6 at various sections or joints of self-positioning arm 204 as shown in FIG. 7. It will be understood that the various motors 208 provide torque for controlling the rotation of arm sections about these axes. Further, it will be understood that certain components of earlier embodiments (e.g., welding wire spool 28 seen in FIG. 2) may pertain to the embodiment of FIG. 7 even if not explicitly shown.

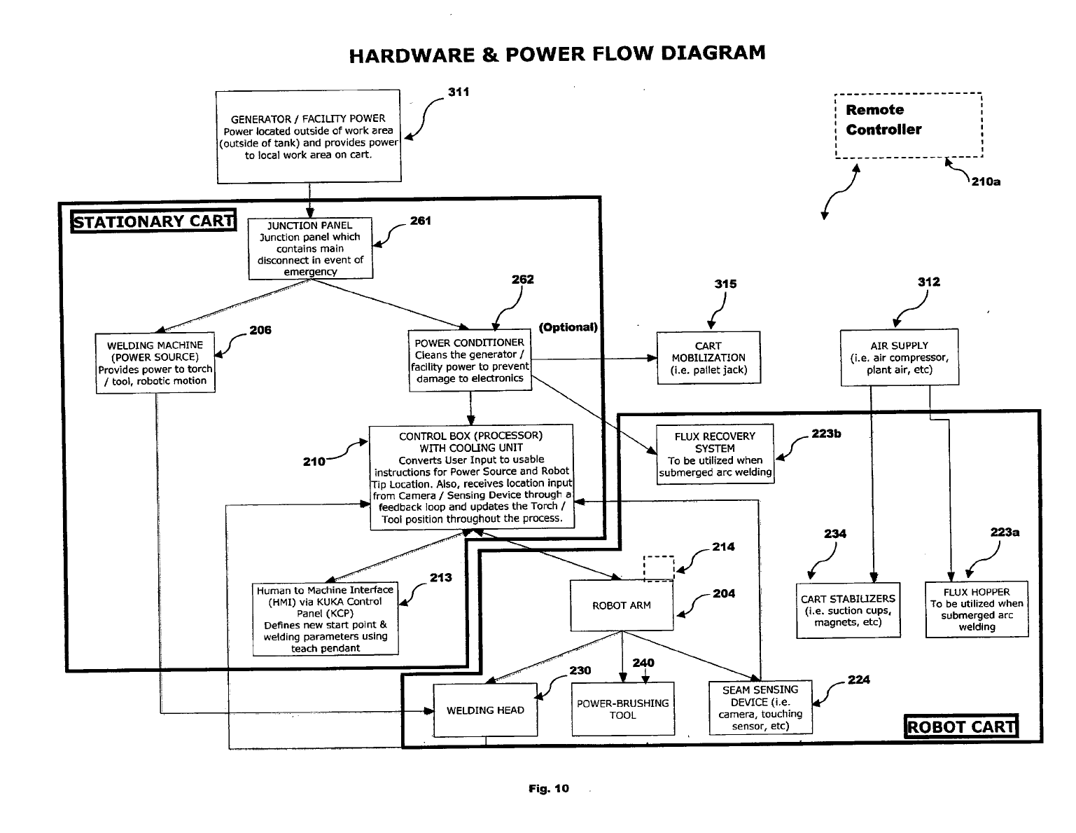

As best seen in FIG. 9, the end of self-positioning arm 204 includes the bracket 250 positioned thereon. Bracket 250 serves as the mounting point for cleaning tool 240 while welding torch 230 connects at the end of arm 204. In this embodiment, welding torch 230 may be a 600 amp robotic MIG gun such as that sold under the “Tough Gun” trademark by Tregaskiss Corporation of Ontario, Canada. As used herein, the term “welding torch” may be used interchangeably with “welding head” or “weld head.” The welding torch may be part of a submerged arc welding system, a flux core welding system, an induction welding system, a plasma welding system, a laser welding system, or any other conventional or future developed welding system. The cleaning tool 240 may be a power brush 241 such as the 25-R sold by SUHNER Industrial Products Corp. of Rome, Ga. Although not explicitly shown in the drawings, the motor for power brush 241 may be mounted on self-positioning arm 204 near the A-3 axis (i.e., to minimize weight on the end of arm 204) and utilize a flexible shaft to deliver torque to the brush element. As an alternative to a brush, cleaning tool 240 could be a grinding head or other abrasive tool. Naturally, alternative embodiments of the welding system could omit use of a cleaning tool and only welding torch 230 would be placed on self-positioning arm 230 (or alternatively, only welding torch 230 and joint sensor 224).

It will be understood that by rotating bracket 250 around axis A6 and rotating the end of arm 204 around axis A5, either welding head 230 or cleaning tool 250 may be brought into operative engagement with the weld joint 305 (as suggested in FIG. 7). FIG. 9 also illustrates a different joint sensor than seen in previous embodiments. FIG. 9 shows joint sensor 224 as being the touch sensor or wand sensor 225 which detects a weld joint when the wand is dragged across the joint. When using this embodiment of touch sensor 225, a low voltage is applied to the plate on which platform 202 is position and touch sensor detects the change in electrical properties when it contacts an adjacent plate (e.g., the weld joint). Again, by the end joint of arm 204 rotating around axis A5, touch sensor 225 is oriented downward in a position to contact the surface to be welded. One example of such a touch sensor is formed of a thin steel wire (e.g., piano wire). The positive and negative leads of a 50V, 30 mA Acopian power supply are run through a normally open (NO) relay to control the energizing of the sensor. The negative lead of the relay is connected to the welding work lead. The positive lead continues through the input of a 48V ABB opto-isolator, and from there to the section piano wire. The system detects when the steel wire is shorted to the welding work lead (i.e., the tank bottom). Naturally, the scope of the invention includes mechanical sensors operating on principles other than detecting a change in electrical properties.

The embodiment of FIG. 7 will further include one or more motion detectors 238 which will detect unexpected objects or personnel within a radius which could result in injury or damage and such motion detection will cause the system controller to significantly slow the rate of movement of self-positioning arm 204 (e.g., to about 10 inches per second) if such objects or personnel are detected. In this embodiment, motion sensor(s) 238 is an OS32C series safety laser scanner sold by Omron Electronics LLC of Schaumburg, Ill. FIG. 7 further illustrates a flux delivery system 222 which comprises the pressure feed flux tank 223b which supplies the powdered welding flux to the section of the weld joint be welded and flux recovery system 223a which recovers the flux as the welding operation progresses. Although not explicitly shown in FIG. 7, it will be understood that hoses from pressure feed flux tank 223b and flux recovery system 223a travel along self-positioning arm 204 to a point adjacent to welding torch 230 as suggested in FIG. 2. In this embodiment, pressure feed flux tank 223b and flux recovery system 223a are provide as part of a system sold under the designation PFR-3 by Weld Engineering Company, Inc. of Shrewsbury, Mass. The flux delivery system may be easily removed when the system is employing a welding method that does not require the application of flux to the welding area.

The particular embodiment of FIG. 7 further includes laser projector 255 positioned on the side of platform 202. One example of laser projector 255 is designated Extra Bright Mini Lase Line Genertor and is available from H-W Fairway International, Inc. of Kent, Ohio. Laser projector 255 will project a laser image 256 onto the tank plates to be welded, where examples of the laser image could include at least two points or alternatively, an image appearing as a continuous line. In preferred embodiments, the distance between where the laser image appears on the tank plate and the laser projector (or some other known reference point) is available to the welding system controller 210. Thus, when an operator positions welding platform 202 with laser image 256 on or very close to the weld joint 305 as suggested in FIG. 7, the welding system controller has a close initial approximation of the location of weld joint 305. Likewise, if the tank plate is of a standard width (e.g., 8 feet or 10 feet), the welding system controller also will have a close approximation of the location of the opposing weld joint on the opposite side of welding platform 202. Laser projector 255 will be adjustable to change the distance from the platform at which the laser image appears on the plates being welded. This distance will typically be adjusted according to the width of the plates being welded. Obviously, the above direct estimation of distance from the welding system to weld joint 305 is merely one example and many other (direct or indirect) methods could be utilize to find an estimation of this distance.

Another distinction between the FIG. 7 embodiment and that of FIG. 2 are the stabilizing legs 234. In FIG. 7, stabilizing legs 234 include vacuum suction cups 235 which are capable of selectively gripping and releasing relatively smooth surfaces such as the tank plates being welded together. The structure of the stabilizing legs will incorporate a vacuum pump 236 which communicates with the space between the bottom of suction cups 235 and the tank plate surface. Thus, by applying a vacuum to this space, suction cups 235 grip the tank plate and by allowing this space to return to atmospheric (or positive) pressure conditions, suction cups release the tank plate. Nonlimiting examples of suction cups 235 are designated FP300 and of vacuum pumps 236 are designated AVM 2, both available from Piab USA, Inc. of Hingham, Mass. As an alternative to suction cups 235, magnets such as seen in FIG. 2 could be employed in conjunction with the stabilizing legs 234.

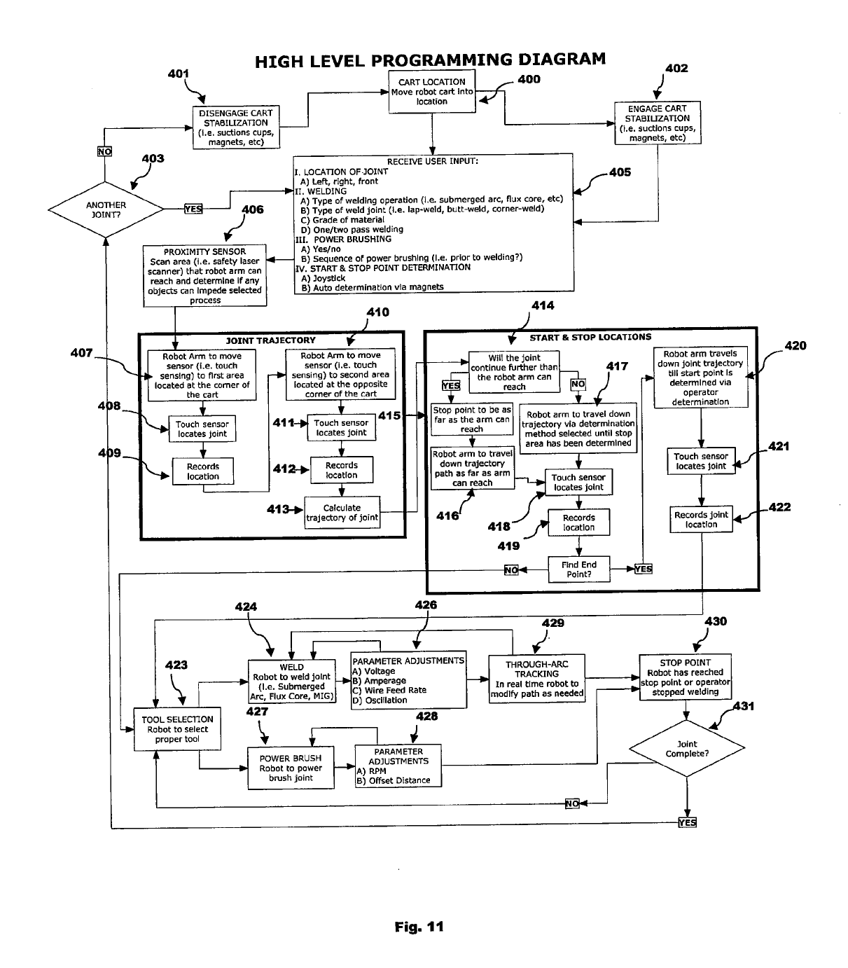

FIG. 8 illustrates a secondary cart or platform 209 which will typically be utilized in conjunction with welding platform 202 seen in FIG. 7. Major components shown in FIG. 8 (illustrated conceptually by box structures) include system controller 210, welding machine 206, and cooling module 207. FIG. 10 is a schematic illustration of hardware components generally associated with both secondary platform 209 and welding platform 202. This embodiment of secondary platform 209 will include a junction panel 261 housing a main disconnect for emergency shut-down of power to the welding system. Power is routed from junction panel 261 to welding machine 206 and system controller 210. In certain embodiments, a power conditioner 262 may be employed to filter amplitude spikes and out-of-phase components from electricity fed to system controller 210. Power to the welding system may be provided by a dedicated generator 311 or may be provided by the power grid available at the location where the welding system is being employed. Cooling module 207 will be employed in high temperature environments to stabilize the temperature of system controller 210 and in this embodiment is also provided by KUKA. A further alternative embodiment may include a remote system controller 210a which controls the welding system through a wireless communication link 214 (e.g., a cellular communications link).

The system includes user interface 213 such as the human machine interface (HMI) provided by KUKA Roboter GmbH for use with its robotic arms. Similar to the above described user interface, the KUKA HMI may include a small view screen and a key-pad, may have directional arrow keys, and/or a joy stick, and/or numerical keys allowing a user to enter numerical information and directional instructions through the HMI.

FIG. 10 also illustrates schematically how the components of welding platform 202 interact with components of secondary platform 209. These components include previously described flux hopper and recovery system 223a and 223b, self-positioning (or robot) arm 204, welding head 230, joint cleaning tool (power-brush) 240, and joint sensor 224. FIG. 10 further shows how in certain embodiments, a pressurized air supply may be used to power flux hopper 223a and the suction cups of stabilization legs 234. Finally, FIG. 10 identifies a cart mobilization device 315 which is employed to move platforms 202 and 209 from plate to plate when the welding system is not self-propelled as the embodiment of FIG. 1. In one preferred embodiment, mobilization device 315 may be pallet jack such as the WP 2300 series (and more specifically the 2335 model) pallet jack provided by Crown Equipment Corporation of New Bremen, Ohio. The forks of such a pallet jack would engage fork apertures 217 on welding platform 202 and secondary platform 209. Obviously many lifting devices other than pallet jacks could be utilized to shift these platforms from position to position. As one example, FIG. 7 illustrates platform 202 as having lift lugs 239 allowing it to be positioned with a crane or other lifting device. Although not specifically shown, secondary platform 209 would have similar lift lugs.

FIG. 11 illustrates a high level flow chart of the functionality which the embodiment of FIG. 7 could employ. When the cart or platform 202 is moved to a location at which it is to perform a welding operation (step 400), the controller in step 402 will engage the stabilization mechanism associated with this embodiment (i.e., suction cups 235). In step 405, an initial series of user inputs is entered through the HMI described above. These inputs may include the general direction of the joint to be welded (e.g., to the left, right, or front of the platform), the type of welding operation, the type of weld joint, the grade of material to be welded, and the number of passes to be made in the welding operation. Inputs may also involve instructions on brushing operations and start/stop point determinations. Naturally, these are merely example inputs and different embodiments could involve fewer or more initial inputs.

In the FIG. 11 embodiment, the system will perform step 406 where the proximity sensor 238 (FIG. 7) determines that there are no unexpected objects within the reach of the robotic arm. Next, the system determines the alignment or the trajectory of the weld joint. First, in step 407 the robot arm moves to a first boundary point inside the robot arm's range of motion and which is expected to be short of the weld joint, for example a point between the weld joint and one corner of the welding platform (e.g., see point “X” in FIG. 7). The robot arm then begins moving the touch sensor 225 across the tank plates until either the weld joint is detected or the robot arm reaches a second boundary (which is beyond the expected location of the weld joint) without detecting the weld joint. If no joint is detected, the robot arm may return to its rest position and await further instructions from the user. If the weld joint is detected as in step 408 (for example point “A” in FIG. 7), the location of that point is recorded (step 409) and the robot arm moves to another boundary point (e.g., approximate the other corner on the same side of the platform) and again begins searching for the weld joint, which if located in step 411 (for example point “B” in FIG. 7), will be recorded in step 412. If the welding controller has detected two points on the weld joint, it may calculate the weld trajectory (i.e., the direction the weld joint runs in relation to the frame of reference used by the controller) in step 413.

Next, the controller will determine the start and stop locations of the welding operation. Typically, the user has made a determination prior to step 405 of whether the length of the joint needing to be welded clearly extends beyond the reach of the robot arm or if the expected weld length appears within the robot arm's range of motion. If the weld length appears beyond the robot arm's reach, the weld path “stop point” will be as far as the arm may reach (step 415) and the robot arm will travel down the trajectory path to the arm's maximum reach (step 416). The robot arm then employs the touch sensor to determine the exact location of the joint at its maximum reach (step 418) and records this location in step 419 (for example point “F” in FIG. 7). Next in step 420, the robot arm travels in the opposite direction along the weld trajectory to its maximum reach (step 420) and uses the touch sensor to locate the weld joint (step 421) and then records this location (for example point “S” in FIG. 7) as the starting weld point (step 422). Alternatively, if the weld length is expected to be less than the robot arm's range of motion in step 414, another method is employed to determine the start/stop locations of the welding operation. For example, the user might use a joy stick on the HMI to move the robot arm to approximately the desired stop point, after which the touch sensor would be used to determine the exact stop point which is recorded in step 419. The user likewise manually directs the robot arm to the approximate start point when the touch sensor again is used to identify the precise location which is recorded in step 422. As an alternative, magnets may have been previously placed on the weld joint at desired start and stop points (e.g., points “F” and “S” in FIG. 7) and the controller identifies these start and stop points by the touch sensor encountering these magnets.

In the FIG. 7 embodiment, the motion sensors 238 will detect objects between the plates and for a limited distance above the plates (e.g., 2 feet). Thus, when the robot arm is moving near the plates, the robot arm itself triggers the motion sensor. As described above, the robot arm will be moved at a reduced speed when the motion sensors are triggered. Therefore, when it is desirable to move the robot arm more rapidly (i.e., to reposition from a start point to an end point with no brushing or welding operation), the robot arm may be raised above the motion sensors 238's height limit of detection and repositioned without being limited to the slower speed imposed when the motion sensors have been triggered.

Once the stop and start welding points are determined, the embodiment of FIG. 11 begins welding operations or a brushing operation (step 423), depending on initial user inputs. If the system is to perform a bushing operation, step 427 contemplates the positioning of bracket 250 (see FIG. 7) such that powered brush 241 is brought into contact with the weld joint and begins cleaning the metal along the weld joint. Step 428 contemplates user input to adjust the brush's rotational speed (rpm) and the distance between the center of the brush and the joint (e.g., whether the brush bristles lightly contact the metal or more aggressively contact the metal by moving the brush bristles further against the joint). Normally the brushing operation will proceed along the length of the weld joint until the stop point is reached in step 430. In typical operations, the brushing step takes place prior to welding, so the joint is not complete in step 431 and the process continues with step 423 next selecting the welding step. Typically the system controller will direct the welding to start at the brushing stop point (as opposed to the robot arm unnecessarily repositioning to the brushing start point). Obviously, embodiments not employing a cleaning tool would eliminate steps 427 and 428.

Based upon earlier inputs of welding information (welding type, material type, joint type), the system controller in step 426 selects the welding parameters and commences welding. Although the system controller has calculated a weld trajectory as described above, certain embodiments will further employ through-arc tracking (step 429) to make more precise alterations of the welding torch path to ensure better quality welds. Through-arc tracking is a well know automated welding technique where changes in voltage and/or current at the weld torch tip are monitored and the position of the welding torch is adjusted to keep the voltage/current within predetermined limits associated with the optimal weld head to weld joint distance. Software for implementing through-arc tracking is available from KUKA Roboter GmbH and other welding machine manufacturers. The welding step will normally continue until the stop point is reached in step 230. Thereafter, step 403 inquires whether there is a further joint which may be welded from the platform 202's current position. If yes, user input is requested in step 405 for the new joint to be welded. If no, the suction cups are released in step 401 in preparation for the platform 202 to be moved such that unwelded joints are once again within the range of motion of the robot arm.

Although the above described welding system has been made in terms of certain specific embodiments, those skilled in the art will recognize many other obvious modification and variations. For example, while the drawings illustrate a method of constructing or repairing tank floors, the same techniques could be used to weld all parts of a tank, including but not limited to, shell plates, shell rings, insert plates, roof plates, floating roof components, annular rings, annular plate, lap plates, striker plates, repads, and sketch plates. Nor are the welding methods limited to tanks, but could be employed on any structure requiring the welding of metal plates or other components. Non-limiting examples of such structures could include ships, barges, pressure vessels, reactors, and tubular metal columns (e.g, as used in offshore drilling platforms). Likewise, the welding system could be employed in a shop environment where it may be utilized as a “welding positioner” to weld shop vessels and shop tanks. Where a method of welding “a series” of plates is described, it will be understood that this “series” includes any number of plates, from as few as two plates to hundreds or thousands of plates. The welding system could also be employed in “overlay” procedures where a thin section of a single plate is reinforced by laying a tight pattern of weld beads to augment the thickness of the thin section.

Further, while the drawing show two carts or platforms in the welding system, some embodiments could include all system components on a single platform while other embodiments could employ three or more platforms. For example, one platform could be used for brushing operations and another platform for welding operations. Alternatively, a smaller, self-propelled cart could be equipped mainly with a controller and joint sensor. This specialized cart would “pre-map” all the weld joints in the area to be welded. This map of weld joints then could be transferred to a cart having the welding machine and robot arm which could weld joints without any delays for locating a weld joint.

As an alternative to the system physically mapping the weld joints, the predicted position of the weld joints could be loaded into system memory base on a plot file created via AutoCAD or equivalent software to generate a dimensionally correct representation of how the tank plates will be positioned in the field. For example, transforming the tank plate's coordinate system from a CAD format into a CNC format prior to loading into the control system. Thereafter, once the welding system is given a proper reference point on the pre-positioned plates, the system could follow and weld the plate joints based solely on the map of plate joints stored in memory. Due to small variances in how the tank plates are fitted, certain embodiments of the welding system may effectively use a supplemental method (e.g., touch sensing) to identify the exact layout of the weld joints prior to welding the plate seams.

A still further cart variation would comprise a cart with some type of track or rail system upon which the robot base and arm would travel up and down the length of the rails. This would allow the robot arm to reach and weld a greater number of plate joints before it was necessary to reposition the cart. All such modifications and variations are intended to come within the scope of the following claims.

1. A method of welding plate joints during construction or repair of a storage tank, the method comprising the steps of:
a. positioning a series of plates forming a tank component next to one another to form a series of joints for welding;
b. positioning a welding system on or adjacent to the series of plates, the welding system including a platform with an articulating welding arm positioned thereon, wherein the articulating arm comprises (i) a rotating base and at least two arm segments connected at a pivot point and extending from the rotating base, (ii) a welding head, and (iii) a joint sensor;
c. directing the articulating arm with a controller to detect a first joint with the joint sensor;
d. beginning to weld the first joint;
e. adjusting the position of the welding head to track the weld joint based on data from the joint sensor;
f. upon reaching a weld termination condition, to cease welding;
g. rotating the base and positioning the welding head adjacent a second weld joint;
h. repeating steps (d) through (f); and
i. maintaining the platform in a substantially stationary position while performing steps (d) through (f).

2. The method according to claim 1, wherein the tank component is at least one of a tank floor, a tank roof, or a tank sidewall.

3. The method according to claim 1, further comprising maintaining the platform in a substantially stationary position while performing steps (d) through (h).

4. The method according to claim 1, wherein the platform comprises a stationary platform with stabilizing legs.

5. The method according to claim 1, wherein prior to the welding step, performing the step of detecting with the joint sensor multiple locations of the welding joint and recording the locations.

6. The method according to claim 1, wherein prior to the welding step, performing the step of engaging releasable stabilizing legs into contact with the tank plates.

7. The method according to claim 6, wherein the stabilizing legs comprise electro-mechanically activated legs and/or vacuum activated legs.

8. The method according to claim 1, where in addition to performing a welding operation, the articulating arm performs at least one of a buffing, a grinding, or a cutting operation.

9. The method according to claim 1, wherein the controller reads from memory a coordinate system corresponding to the series of plates and positions the articulating arm base on the coordinate system.

10. The method according to claim 1, wherein the controller positions the articulating arm at a first boundary point and moves the articulating arm in a first direction until the weld joint is detected.

11. The method according to claim 10, wherein the controller stops the movement of the articulating arm at a second boundary point if no weld joint is detected.

12. The method according to claim 10, wherein the systems performs the steps of determining a first and second point on the weld joint with the joint sensor and calculates a weld trajectory therefrom.

13. The method according to claim 12, wherein the system determines a further stop point and a further start point along the weld trajectory.

14. The method according to claim 13, wherein the start point and stop point are approximately the maximum reach of the articulating arm along the weld trajectory.

15. The method according to claim 13, wherein the start point and stop point are approximately set by contemporaneous user interface control.

16. The method according to claim 12, wherein the system adjusts weld torch path along the weld trajectory during the welding step base upon through-arc sensing.

17. The method according to claim 1, wherein the articulating arm terminates in a rotating bracket.

18. The method according to claim 10, wherein the platform is moved with a pallet truck.

19. The method according to claim 1, wherein a light marker is projected from the platform and the step of positioning the system includes aligning the light marker with a weld joint.

20. The method according to claim 19, wherein the light marker comprises a laser beam projected as a line onto the plates.

21. The method according to claim 1, further comprising the step of positioning at least one magnet approximately along the weld joint to indicate an approximate stop point of a welding operation.

22. The method according to claim 1, wherein the stabilizing legs include suction cups attached to the platform and the suction cups are actuated after positioning of the platform.

23. An automated welding system comprising:
a. a welding platform;
b. a self-positioning arm mounted on the platform, the self-positioning arm including a rotating base and at least two arm segments connected at a pivot point;
c. a welding machine including a welding head attached to the self-positioning arm;
d. a weld joint sensor;
e. a controller communicating with the self-positioning arm, the joint sensor, and the welding machine, the controller programmed to execute the following steps:
i) detect the position of a weld joint with the joint sensor;
ii) position the welding head adjacent to the weld joint and begin welding the joint at a weld head velocity which is different from a platform velocity;
iii) adjust the position of the welding head to track the weld joint; and
iv) upon reaching a weld termination condition, to cease welding.

24. The automated welding system according to claim 23, wherein the welding platform is a first platform including the self-positioning arm and the system comprises a second platform including the welding machine.

25. The automated welding system according to claim 24, wherein the first platform includes a flux delivery and recovery system comprising a delivery hose and a recovery hose attached to the self-positioning arm.

26. The automated welding system according to claim 23, wherein the platform comprises a plurality of stabilizing legs and each stabilizing leg comprises at least one flexible inverted cup and a vacuum passage communicating with the cup.

27. The automated welding system according to claim 23, wherein the joint sensor comprises a mechanical sensing device.

28. The automated welding system according to claim 23, wherein a laser projector on the platform projects a laser line a know distance from the platform, allowing the system to approximate the location of weld joints on a standard sized plate on which the platform is position.
